(19) United States
(12) Patent Application Publication
(10) Pub. No.: US 2011/0058355 A1
(43) Pub. Date: Mar. 10, 2011

(54) LIQUID CRYSTAL DISPLAY DEVICE AND METHOD FOR ASSEMBLING SAME

(75) Inventors: Hsuan-Yu Teng, Miao-Li County (TW); Mei-Fang Huang, Miao-Li County (TW)

(73) Assignee: Chimei Innolux Corporation, Miao-Li County (TW)

(21) Appl. No.: 12/770,762

(22) Filed: Apr. 30, 2010

(30) Foreign Application Priority Data
Sep. 8, 2009 (CN) 200910306703.6

(51) Int. Cl. G09F 13/08

(52) U.S. Cl. 362/97.2

(57) ABSTRACT

A liquid crystal display (LCD) device includes a back cover portion, a backlight module, a side frame portion, a panel assembly and a bezel. The backlight module is directly positioned on the back cover portion. The side frame portion is positioned on the back cover portion and surrounds the backlight module. The panel assembly is positioned on the side frame portion and opposite to the backlight module. The bezel is fixed to a front of the back cover portion. A method for assembling the LCD device is also provided.

### BACKGROUND

1. Technical Field

The present disclosure relates generally to liquid crystal display (LCD) devices and, more particularly, to an LCD device having a backlight module without a dedicated housing.

2. Description of Related Art

LCD devices have largely replaced conventional cathode ray tube (CRT) display devices due to their excellent display quality and thinner, lighter construction.

However, market and industry demands continually require further reduction of LCD device thickness for enhanced portability, necessitating ongoing structural modification.

Therefore, there is room for improvement within the art.

### BRIEF DESCRIPTION OF THE DRAWINGS

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an assembled, isometric view of a first embodiment of an LCD device, the LCD device including a back cover and a side frame (not visible).

FIG. 2 is a isometric view of part of the back cover and the side frame of the LCD device of FIG. 1.

FIG. 3 is a cross-section of part of the LCD device of FIG. 1, taken along line III-III thereof.

FIG. 4 is a cross-section of part of the LCD device of FIG. 1, taken along line IV-IV thereof.

FIG. 5 is an assembled, isometric view of a second embodiment of an LCD device, the LCD device including a back cover and a side frame (not visible).

FIG. 6 is an isometric view of the back cover and the side frame of the LCD device of FIG. 5.

FIG. 7 is a cross-section of part of the LCD device of FIG. 5, taken along line VII-VII thereof.

FIG. 8 is an assembled, isometric view of a third embodiment of an LCD device.

FIG. 9 is a cross-section of part of the LCD device of FIG. 8, taken along line IX-IX thereof.

FIG. 10 is a cross-section view of part of a fourth embodiment of an LCD device.

FIG. 11 is a perspective view of a light guide plate used in an LCD device that is a variation of the LCD device of FIG. 10.

FIG. 12 is a flowchart of an exemplary method for assembling an LCD device.

### DETAILED DESCRIPTION

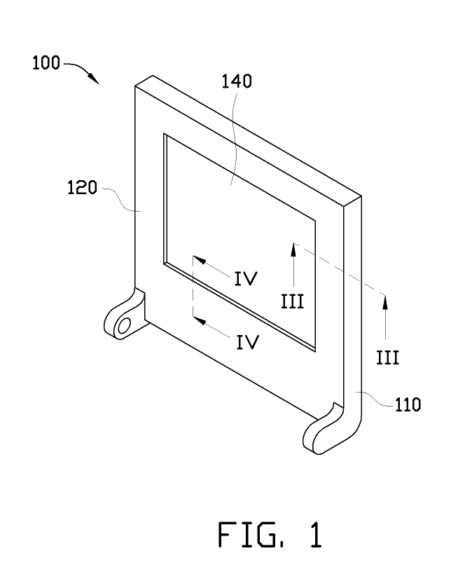

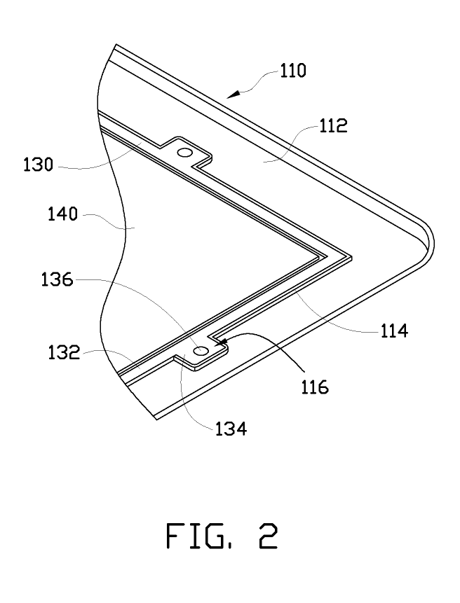

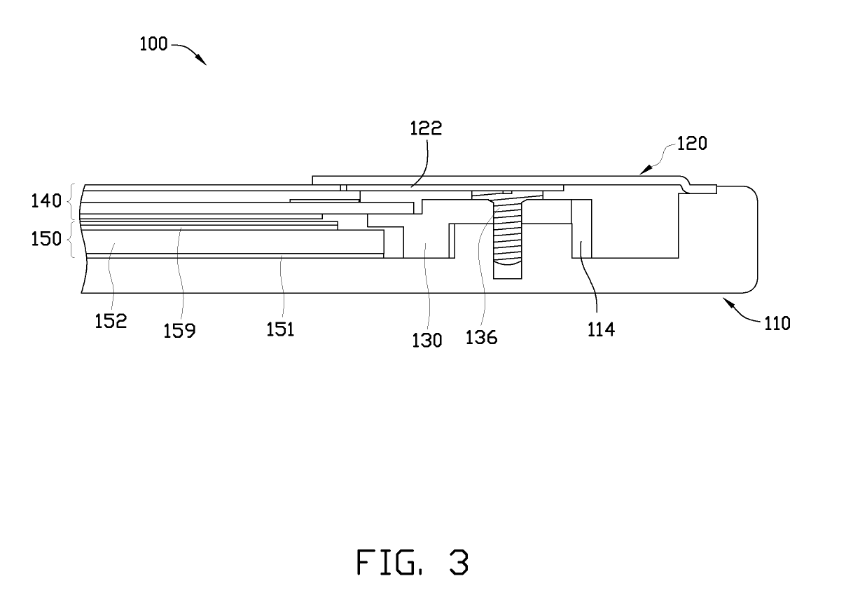

Referring to FIGS. 1 through 3, a first embodiment of an LCD device 100 includes a back cover 110, a bezel 120, a side frame 130, a panel assembly 140, and a backlight module 150. The bezel 120 is fixed on the back cover 110, and the panel assembly 140 is positioned between the bezel 120 and the back cover 110.

The back cover 110 can be metal, such as aluminum alloy or stainless alloy. The back cover 110 can instead be nonmetallic material, such as plastic.

The back cover 110 includes a main body 112 and a holding frame 114. The holding frame 114 is formed on the main body 112 and surrounds the side frame 130. In the illustrated embodiment, a plurality of portions along a perimeter of the holding frame 114 are in the form of generally U-shaped protrusions that jut out from a main portion of the holding frame 114 in a direction toward an outside of the LCD device 100, parallel to the back cover 110. Thereby, a plurality of positioning grooves 116 is defined inside the U-shaped protrusions, respectively. In the illustrated embodiment, the side frame 130 includes a main portion 132, and a plurality of positioning protrusions 134 extending outward from an outer edge of the main portion 132. The positioning protrusions 134 are received in the positioning grooves 116, respectively. The positioning protrusions 134 are fixed to the back cover 110 via fasteners 136, respectively. In the illustrated embodiment, the fasteners 136 are screws. Thus, the side frame 130 is firmly fixed on the back cover 110. In an alternative embodiment, there may be only one U-shaped protrusion, one positioning groove 116, one positioning protrusion 134, and one fastener 136.

The backlight module 150 is directly positioned on the back cover 110, below the panel assembly 140. In the illustrated embodiment, there is a small gap between the backlight module 150 and the panel assembly 140. Nevertheless, the backlight module 150 can be held in position between the back cover 110 and the panel assembly 140. Thus, there is no need for a dedicated housing in the LCD device 100 to support the backlight module 150. Accordingly, a thickness of the LCD device 100 can be reduced.

As described above, the side frame 130 is fixed on the back cover 110; and the side frame 130 surrounds the backlight module 150 and supports the panel assembly 140. In addition, an adhesive member 122 is positioned between the panel assembly 140 and the bezel 120. In the illustrated embodiment, the adhesive member 122 is simultaneously further positioned between at least one of the fasteners 136 and the bezel 120. Thus, the side frame 130 and the panel assembly 140 are firmly held in position, in cooperation with the back cover 110 and the bezel 120.

The backlight module 150 includes a reflective plate 151 and a light guide plate 152. The reflective plate 151 has a first surface attached to the back cover 110. The light guide plate 152 is positioned on a second surface of the reflective plate 151 which is at an opposite side of the light guide plate 152 from the first surface.

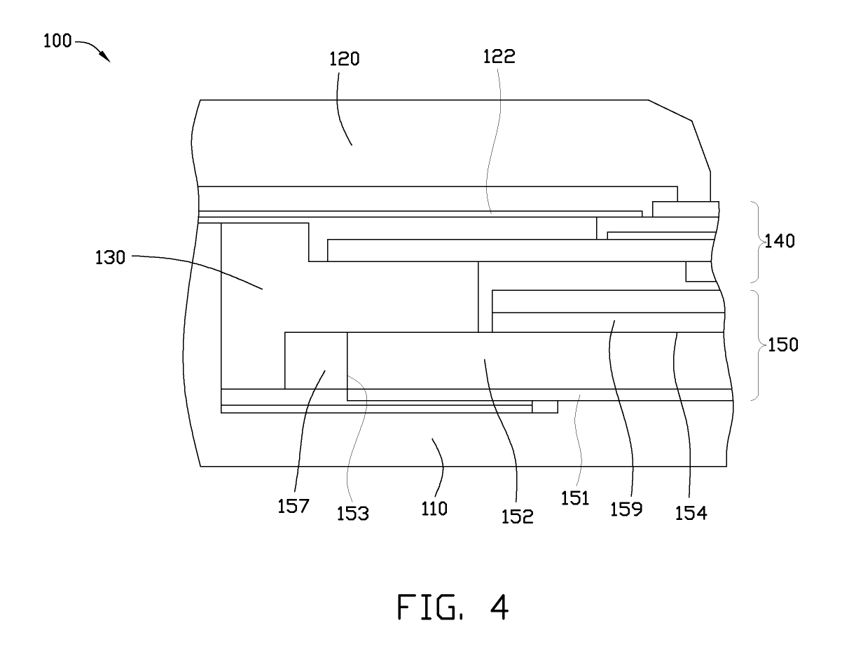

Referring also to FIG. 4, the backlight module 150 further includes a multifunction film 159 positioned on the light guide plate 152. The multifunction film 159 can diffuse light as with a conventional light diffusion sheet, and also converge light as with a conventional prism sheet. That is, the multifunction film 159 can replace what is ordinarily a plurality of optical sheets, thereby further reducing the thickness of the LCD device 100.

The backlight module 150 further includes a plurality of light sources 157 positioned adjacent to a light incident surface 153 of the light guide plate 152. A light output surface 154 of the light guide plate 152 faces toward the panel assembly 140. The multifunction film 159 is attached to the light output surface 154. Each light source 157 can be a light-emitting diode (LED). Alternatively, the light sources 157 can be replaced by a single linear light source such as a cold cathode fluorescent lamp (CCFL).

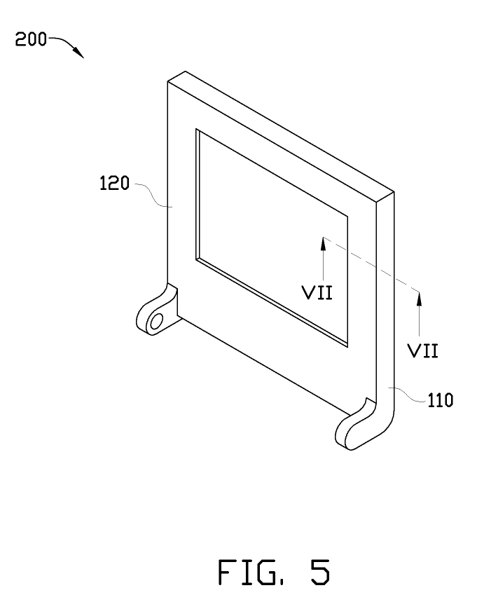

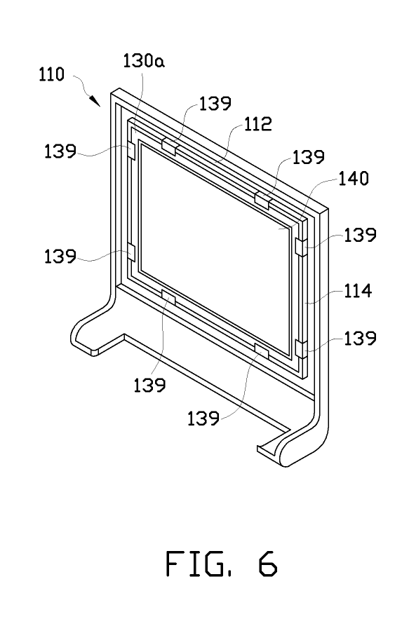

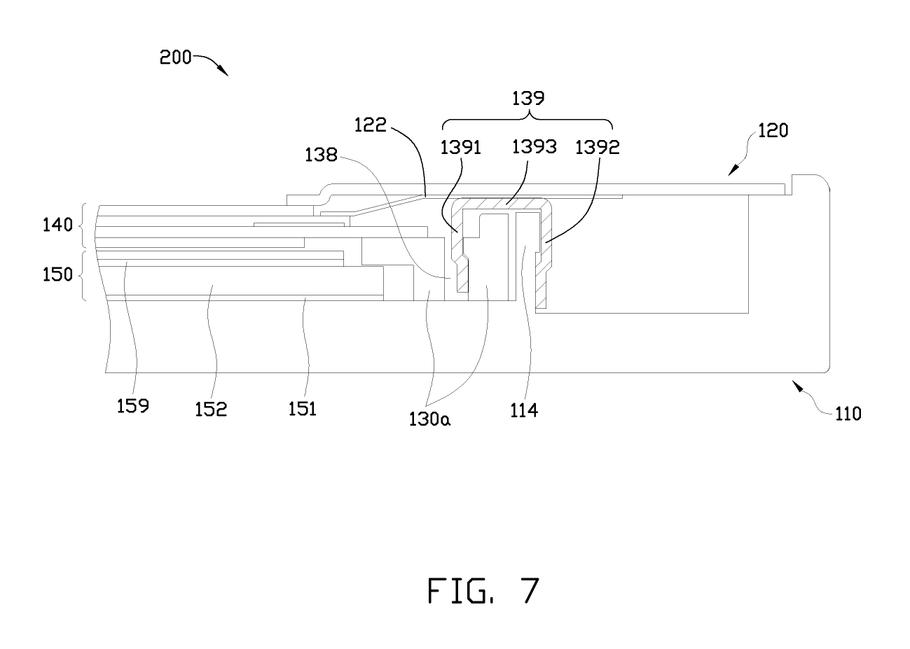

Referring to FIGS. 5 through 7, a second embodiment of an LCD device 200 is similar to the LCD device 100 of the first embodiment. In the LCD device 200, a side frame 130a defines a plurality of assembly holes 138. The LCD device 200 further includes a plurality of elastic members 139. In the illustrated embodiment, each elastic member 139 is generally in the form of a U-shaped clip. Each elastic member 139 includes a first leg 1391, a second leg 1392, and a connecting portion 1393 connecting the first leg 1391 to the second leg 1392. The first leg 1391 is received in a corresponding assembly hole 138 of the side frame 130a, and the second leg 1392 is attached to an outer surface of the holding frame 114. In addition, the adhesive member 122 is positioned between the panel assembly 140 and the bezel 120. In the illustrated embodiment, the adhesive member 122 is simultaneously further positioned between the connecting portion 1393 of at least one of the elastic members 139 and the bezel 120. Thus, the side frame 130a and the panel assembly 140 are firmly held in position, in cooperation with the back cover 110 and the bezel 120.

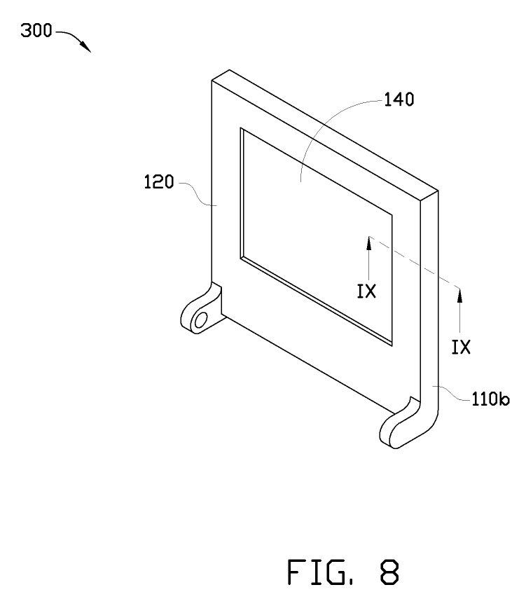

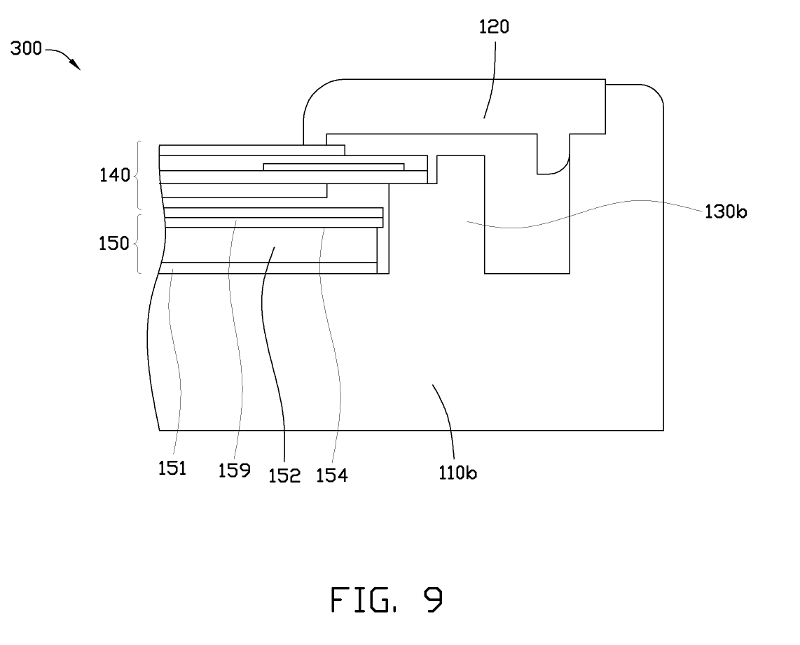

Referring to FIGS. 8 and 9, a third embodiment of an LCD device 300 differs from the LCD device 100 of the first embodiment only in that a side frame 130b is integrally formed with a back cover 110b, and the adhesive member 122 is omitted. That is, the side frame 130b and the back cover 110b are portions of a single, one-piece, monolithic body without any internal seams. The side frame 130b surrounds the backlight module 150, and supports the panel assembly 140. Since the side frame 130b and the back cover 110b are integrally formed, the LCD device 300 is easily assembled.

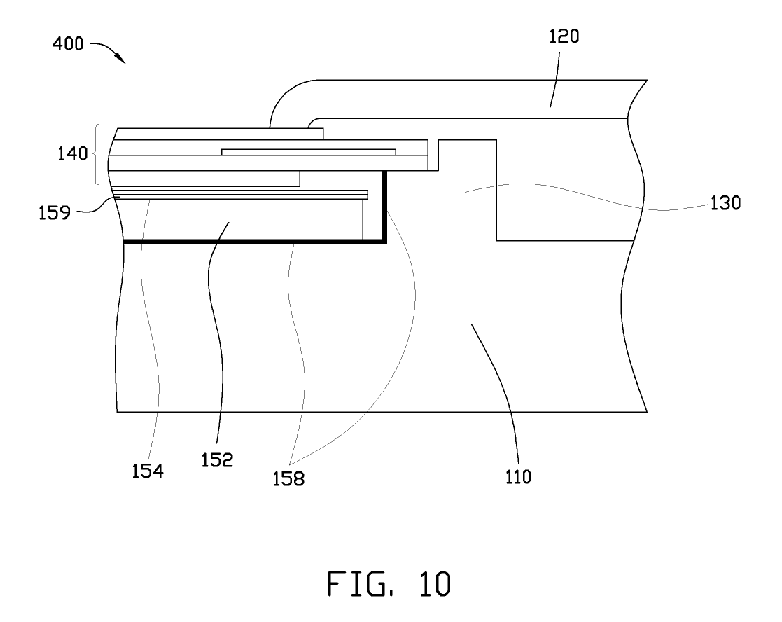

Referring to FIG. 10, a fourth embodiment of an LCD device 400 differs from the LCD device 300 of the third embodiment only in that the reflective plate 151 of the LCD device 300 is replaced by a reflective layer 158. The reflective layer 158 is coated on the side frame 130 and also the back cover 110, and the reflective layer 158 on the side frame 130 surrounds three lateral sides of the light guide plate 152 other than the light incident surface 153.

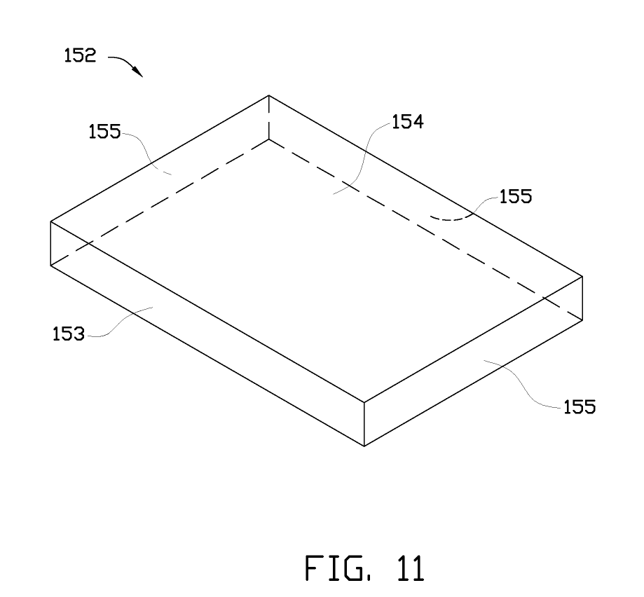

Referring to FIG. 11, in a variation of the fourth embodiment, the reflective layer 158 is omitted, and instead the light guide plate 152 is coated with reflective material. The light guide plate 152 includes the light incident surface 153 and the light output surface 154, and three light reflective surfaces 155 connecting the light output surface 154. The light reflective surfaces 155 are coated with the reflective material.

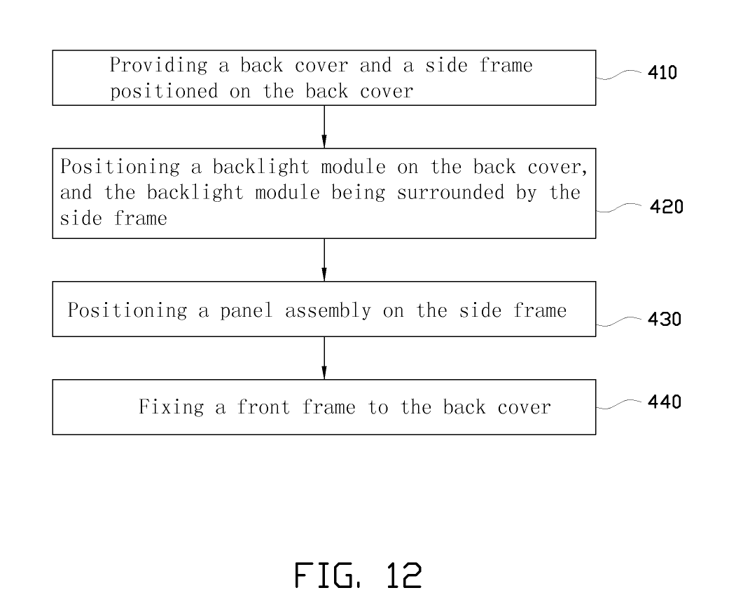

FIG. 12 shows an exemplary method for assembling an LCD device, such as, for example, the LCD device 100 of the first embodiment. The method includes the following steps.

In step 410, the back cover 110 and the side frame 130 are provided, and the side frame 130 is positioned on the back cover 110. In step 420, the backlight module 150 is directly positioned on the back cover 110, and surrounded by the side frame 130. In step 430, the panel assembly 140 is positioned on the side frame 130, opposite to the backlight module 150. In step 440, the bezel 120 is fixed to the back cover 110.

In particular, in step 420, the reflective plate 151, the light guide plate 152, and the multifunction film 159 of the backlight module 150 are positioned on the back cover 110 in that order.

It should be pointed out that in the case of the method being adapted for assembling the LCD device 200, in step 410, the side frame 130 can be fixed to the back cover 110 by the elastic members 139. In the case of the method being adapted for assembling the LCD device 300, in step 410, the side frame 130 integrally formed with the back cover 110 can be provided.

It is believed that the present embodiments and their advantages will be understood from the foregoing description, and it will be apparent that various changes may be made thereto without departing from the spirit and scope of the disclosure or sacrificing all of its material advantages.

What is claimed is:

1. A liquid crystal display (LCD) device, comprising:
a back cover portion;
a backlight module directly positioned on the back cover portion;
a side frame portion positioned on the back cover portion and surrounding the backlight module;
a panel assembly positioned on the side frame portion, opposite to the backlight module; and
a bezel fixed to a front of the back cover portion.

2. The LCD device of claim 1, wherein the back cover portion comprises a main body and a holding frame formed on the main body, and the holding frame surrounds the side frame portion.

3. The LCD device of claim 1, wherein the side frame portion comprises a main portion and at least one positioning protrusion extending from an edge of the main portion, and the back cover portion defines at least one positioning groove, in which the at least one positioning protrusion is received.

4. The LCD device of claim 3, wherein the at least one positioning protrusion of the side frame portion is fixed to the back cover portion via at least one fastener.

5. The LCD device of claim 1, further comprising a plurality of elastic members fixing the side frame portion and the back cover portion together.

6. The LCD device of claim 6, wherein each elastic member comprises a first leg, a second leg, and a connecting portion connecting the first leg to the second leg, the side frame portion defines a plurality of assembly holes, the first leg is received in one corresponding assembly hole of the side frame portion, and the second leg is attached to an outer surface of the side frame portion.

7. The LCD device of claim 1, wherein the side frame portion is integrally formed with the back cover portion.

8. The LCD device of claim 1, wherein the backlight module comprises a reflective plate and a light guide plate, the reflective plate attached to the back cover portion and the light guide plate positioned on the reflective plate.

9. The LCD device of claim 8, wherein the backlight module further comprises a multifunction film positioned on the light guide plate.

10. The LCD device of claim 8, wherein the backlight module further comprises a plurality of light sources positioned adjacent to a light incident surface of the light guide plate.

11. The LCD device of claim 1, wherein the backlight module comprises a reflective layer and a light guide plate, the reflective layer coated on the side frame portion and the back cover portion, and the reflective layer on the side frame portion surrounding three sides of the light guide plate.

12. The LCD device of claim 1, wherein the backlight module comprises a light guide plate comprising a side light incident surface, a top light output surface adjacent to the light incident surface, and a plurality of side light reflective surfaces each adjacent to the light output surface, and the side light reflective surfaces are coated with reflective material.

13. A method for assembling a liquid crystal display (LCD) device, the method comprising:
providing a back cover portion and a side frame portion positioned adjacent the back cover portion;
positioning a backlight module on the back cover portion, the backlight module surrounded by the side frame portion;
positioning a panel assembly on the side frame portion; and
fixing a bezel to a front of the back cover portion.

14. The method of claim 13, wherein the side frame portion is fixed on the back cover portion by at least one fastener.

15. The method of claim 13, wherein after the side frame portion is positioned on the back cover portion, the side frame portion and the back cover portion are fixed together by a plurality of elastic members.

16. The method of claim 13, wherein the side frame portion is integrally formed with the back cover portion.

17. The method of claim 13, wherein the backlight module comprises a reflective plate and a light guide plate, the reflective plate attached to the back cover portion and the light guide plate positioned on the reflective plate.

18. The method of claim 17, wherein the backlight module further comprises a multifunction film positioned on the light guide plate.

19. The method of claim 17, wherein the backlight module further comprises a plurality of light sources positioned adjacent to a light incident surface of the light guide plate.

20. The method of claim 13, wherein the backlight module comprises a reflective layer and a light guide plate, the reflective layer coated on the side frame portion and the back cover portion, and the reflective layer on the side frame portion surrounding three sides of the light guide plate.
